(19) United States
(12) Patent Application Publication
(10) Pub. No.: US 2009/0045024 A1
(43) Pub. Date: Feb. 19, 2009

(54) Overrunning Radial Coupling Assembly Having Dual Bearing Support

(75) Inventor: Stephen M. Ruth, Holly, MI (US)

Correspondence Address: BROOKS KUSHMAN P.C., 1000 TOWN CENTER, TWENTY-SECOND FLOOR, SOUTHFIELD, MI, 48075, US

(73) Assignee: Means Industries, Inc., Saginaw, MI (US)

(21) Appl. No.: 12/189,429

(22) Filed: Aug. 11, 2008

Related U.S. Application Data
(60) Provisional application No. 60/964,489, filed on Aug. 13, 2007.

(51) Int. Cl. F16D 11/06

(52) U.S. Cl. 192/43.1

(57) ABSTRACT

An overrunning radial coupling assembly having dual bearing support is provided. The assembly includes an inner member having an outer peripheral surface and an outer member having an inner peripheral surface adjacent the outer peripheral surface in radially inner and radially outer relationship. At least one of the members is mounted for rotation about an axis. One of the members includes pockets angularly spaced about the axis. Each of the pockets has a closed end and an open end located axially opposite the closed end. The assembly further includes a plurality of pawls. Each of the pawls is located in a pocket and is supported to pivot toward the peripheral surface of the other of the members. The assembly still further includes a retainer secured to one of the members. The retainer covers the open end of the pockets. The inner and outer peripheral surfaces define a first radial bearing interface adjacent the closed end of each of the pockets. The retainer has a bearing surface which together with one of the peripheral surfaces define a second radial bearing interface adjacent the open end of each of the pockets. The first and second radial bearing interfaces react and carry an internal moment load to prevent contact of the peripheral surfaces during overrunning.

### CROSS-REFERENCE TO RELATED APPLICATIONS

This application claims the benefit of U.S. provisional patent application Ser. No. 60/964,489 filed Aug. 13, 2007 and entitled “Pawl-Type One-Way Clutch Having Dual Bearing Support.”

### BACKGROUND OF THE INVENTION

1. Technical Field

This invention relates to overrunning radial coupling assemblies such as one-way clutches.

2. Background Art

Overrunning coupling assemblies may be used for transferring torque from a driving member to a driven member in a variety of structural environments. This permits the transfer of torque from a driving member to a driven member while permitting freewheeling motion of the driving member relative to the driven member when torque is interrupted. Such couplings often comprise an outer race concentrically disposed with respect to an inner race, the outer race having cammed surfaces that define a pocket in which coupling rollers are assembled.

A driving member is connected to one race, and a driven member is connected to the other race. During torque transfer from the driving member to the driven member, the rollers become locked with a camming action against the cam surfaces, thereby establishing a positive driving connection between the driving member and the driven member. When the torque is interrupted, the driven member may freewheel relative to the driving member as the rollers become unlocked from their respective cam surfaces.

Another common overrunning coupling includes inner and outer races wherein one race is connected to a driving member and the other race is connected to the driven member. Overrunning coupling sprags are disposed between the inner cylindrical surface of the outer race and the outer cylindrical surface of the inner race so that the sprags lock the races together as torque is delivered to the driven member. The sprags become unlocked with respect to the inner and outer race surfaces when torque transfer is interrupted.

For purposes of this application, the term coupling should be interpreted to include clutches or brakes wherein one of the races or members is drivably connected to a torque delivery element of a transmission and the other race or member is drivably connected to another torque delivery element or is anchored and held stationary with respect to a transmission housing. The terms coupling, clutch and brake may be used interchangeably.

A pocket plate may be provided with angularly disposed recesses or pockets about the axis of a one-way clutch. The pockets are formed in the planar surface of the pocket plate. Each pocket receives a torque transmitting strut, one end of which engages an anchor point in a pocket of the pocket plate. An opposite edge of the strut, which may hereafter be referred to as an active edge, is movable from a position within the pocket to a position in which the active edge extends outwardly from the planar surface of the pocket plate. The struts may be biased away from the pocket plate by individual springs.

A notch plate may be formed with a plurality of recesses or notches located approximately on the radius of the pockets of the pocket plate. The notches are formed in the planar surface of the notch plate.

Referring now to the drawings, there is illustrated in FIGS. 1 and 2 portions of a one-way brake assembly (FIG. 1 taken from published U.S. patent application 2006/0025279) and a one-way clutch assembly (FIG. 2 taken from published U.S. patent application 2006/0021838). Parts or features of the clutch assembly which are the same or similar to the corresponding parts or features of the brake assembly have the same reference numeral but a single prime designation.

The brake assembly is typically integrated with planetary pinion carriers for automatic transmissions. The brake and clutch assemblies include an inner race or rocker ring, generally indicated at 12 and 12′, respectively, (the rocker 12 being formed integrally with a pinion carrier 13), an outer race or cam ring, generally indicated at 14 and 14′, respectively, and a plurality of rockers 16 and 16′, respectively, each rocker being located in a pocket formed in the inner races 12 or 12′ and angularly spaced mutually about central axes (not shown). The inner periphery of the outer races 14 and 14′ are formed with a plurality of cams or notches angularly spaced mutually about the axes.

When the inner races 12 and 12′ (and the carrier 13) rotate in a first direction faster than the outer races 14 and 14′, respectively, each rocker 16 and 16′, respectively, pivots in a second direction opposite the first direction in its pocket away from engagement with the notches due to contact of the rockers 16 and 16′ with the inner radial surface of the outer race 14 and 14′. This allows the inner races 12 and 12′ (and the carrier 13) to rotate freely in the first direction about their axes relative to their outer races 14 and 14′, respectively. When the inner races 12 and 12′ attempt to rotate in the second direction relative to the outer races 14 and 14′, the inner races (and the carrier 13) and outer races are engaged or driveably connected mutually by engagement of the rockers 16 and 16 with their respective notches.

When the brake and clutch assemblies are engaged, each engaged rocker 16 or 16′ transmits a force between the inner and outer races 12 and 12′, and 14 and 14′, respectively, due to its contact with the inner surface of the pocket and with the radially directed surface of the engaged notch.

A recess located at each pocket contains a spring, such as a helical coiled compression spring or an accordion compression spring, for urging each rocker 16 or 16′ to pivot in its pocket toward engagement with its corresponding notches. Referring specifically to FIG. 1, when the carrier 13 is assembled, an axial surface of a bushing 18 contact an inner axial surface 20 of a radial flange 22 of the cam ring 14. The outer radial surface of the cam ring 14 is formed with an axial spline 26 by which the cam ring 14 is driveably connected to a splined inner surface (not shown) of the transmission housing (not shown).

The surface 20 is formed with radially directed grooves 24, which carry fluid lubricant, preferably transmission oil, radially outward to a radial inner surface 23 of the bushing 18. Oil enters the radial grooves 24 and travels axially leftward across the inner radial surface 23 on the bushing 18, to a radial space 25, which directs the oil radially outward to a surface 27, across the width of the rocker ring 12 and across the surfaces of the rockers 16. The bushing 18 pilots the rings 12 and 14 into their correct positions and eliminates the need to machine along the notches or cams (not shown) of the cam ring 14 or the radial outer surface area 34 of the rocker ring 12. Lubricating oil is precisely directed radially along the grooves 24 to the bushing 18, then axially between surfaces 34 on the rocker ring 12, and the radial inner surface 23 of the bushing 18 to the rockers 16. The lubricant flows along this path due to a centrifugal pressure head developed as the brake rotates about its axis. An axial surface 28 of the rocker ring 12 contacts a retaining ring 30, which closes the axial end of each pocket (not shown), resiliently engages a recess 35 formed on the cam ring 14, and is retained in the recess 35. The retaining ring 30 secures the components in position on the carrier 13.

Referring specifically to FIG. 2, the clutch has a rocker plate 12′ formed with angularly spaced pockets and spring recesses, each pocket containing a rocker 16′ that pivots in a respective pocket alternately to engage and to disengage the notches formed on the radially inner surface of the cam plate 14′. A bushing 18′ of powered metal fits within the cam plate 14′.

When the clutch is assembled, an axial surface of the bushing 18′ contacts an inner axial surface 20′ of a flange 22′ of the plate 14′. The surface 20′ is formed with radially directed grooves 24′ which carry fluid lubricant, preferably transmission oil, radially outward a radial inner surface 23′ of the bushing 18′. Oil enters the radial grooves 24′ through holes formed through a drive system component which is connected to the clutch. The oil travels axially leftward across the inner radial surface 23′ on the bushing 18′, to a radial space 25′, which directs the oil radially outward to a surface 27′, across the width of the rocker plate 12′ and across the surface of the rockers 16′. The bushing 18′ pilots the inner and outer races 12′ and 14′, respectively, and eliminates the need to machine along the notches or cams of the outer race 14′ or the radial outer surface area 38 of the rocker plate 12′. Lubricating oil is precisely directed radially along the grooves 24′ to the bushing 18′, then axially between surfaces 34′ on the rocker plate 12′ and the inside diameter surface 23′ of the bushing 18′ to the rockers 16′. The lubricant flows along this path due to a centrifugal pressure head developed as the clutch rotates about its axis.

The radial outer surface of the cam plate 14′ is formed with splines 26′, by which the cam plate 14′ is driveably connected to a drive system. Similarly, the radially inner surface of the rocker plate 12′ is formed with splines 36, by which the rocker plate 12′ is driveably connected to a component of the drive system.

An axial surface 28′ of rocker plate 12′ contacts a retainer ring 30′, which closes the axial end of each pocket and is retained in position by a snap ring 32, which engages a recess 35′ formed on the cam plate 14′.

Other related patent references include U.S. Pat. Nos. 6,854,577; 5,927,455; 6,244,965; 6,116,394; 5,964,331; and 7,258,214 and published U.S. patent applications 2006/0278487 and 2007/0131509.

### SUMMARY OF THE INVENTION

An object of the present invention is to provide an improved overrunning radial coupling assembly having dual bearing support.

In carrying out the above object and other objects of the present invention, an overrunning radial coupling assembly having dual bearing support is provided. The assembly includes an inner member having an outer peripheral surface and an outer member having an inner peripheral surface adjacent the outer peripheral surface in radially inner and radially outer relationship. At least one of the members is mounted for rotation about an axis. One of the members includes pockets angularly spaced about the axis. Each of the pockets has a closed end and an open end located axially opposite the closed end. The assembly further includes a plurality of pawls each of which is located in a pocket and is supported to pivot toward the peripheral surface of the other of the members. The assembly still further includes a retainer secured to one of the members. The retainer covers the open end of the pockets. The inner and outer peripheral surfaces define a first radial bearing interface adjacent the closed end of each of the pockets. The retainer has a bearing surface which together with one of the peripheral surfaces define a second radial bearing interface adjacent the open end of each of the pockets. The first and second radial bearing interfaces react and carry an internal moment load to prevent contact of the peripheral surfaces during overrunning.

The assembly may further include biasing members. Each of the biasing members may urge a pawl toward the peripheral surface of the other of the members.

The retainer may include a plate-like bushing.

The assembly may further include a recess located in one of the members and a snap ring seated in the recess for holding the retainer adjacent the open end of the pockets.

The inner and outer members may be plate-like members.

The coupling assembly may be a pawl-type, one-way clutch.

The inner member may be a pocket plate and the outer member may be a cam plate.

The inner member may have splines for driving connection to a driven member or carrier.

The outer member may have splines for connection to another member.

Relative rotation between the inner and outer members in a direction about the axis may permit overrunning.

A plurality of notches may be formed in one of the peripheral surfaces and the pawls may engage the notches in an engaged position of the assembly.

The pawls may be received and retained in the inner member.

The pawls may be received and retained in the pockets so as to be free-floating.

Further in carrying out the above object and other objects of the present invention, an overrunning radial coupling assembly having dual bearing support is provided. The assembly includes an inner member having an outer peripheral surface and an outer member having an inner peripheral surface adjacent the outer peripheral surface in radially inner and radially outer relationship. At least one of the members is mounted for rotation about an axis. One of the members includes pockets angularly spaced about the axis. Each of the pockets has a closed end and an open end located axially opposite the closed end. The assembly still further includes a plurality of pawls, each of which is located in a pocket and supported to pivot toward the peripheral surface of the other of the members. The assembly includes biasing members each of which urges a pawl toward the peripheral surface of the other of the members. The assembly still further includes a retainer secured to one of the members. The retainer covers the open end of the pockets. The inner and outer peripheral surfaces define a first radial bearing interface adjacent the closed end of each of the pockets. The retainer has a bearing surface which together with one of the peripheral surfaces define a second radial bearing interface adjacent the open end of each of the pockets. The first and second radial bearing interfaces react and carry an internal moment load to prevent contact of the peripheral surfaces during overrunning.

Still further in carrying out the above object and other objects of the present invention, an overrunning, radial, pawl-type one-way clutch assembly having dual bearing support is provided. The assembly includes an inner member having an outer peripheral surface and an outer member having an inner peripheral surface adjacent the outer peripheral surface in radially inner and radially outer relationship. At least one of the members is mounted for rotation about an axis. One of the members includes pockets angularly spaced about the axis. Each of the pockets has a closed end and an open end located axially opposite the closed end. The assembly further includes a plurality of pawls each of which is located in a pocket and supported to pivot toward the peripheral surface of the other of the members. The assembly still further includes a retainer secured to one of the members. The retainer covers the open end of the pockets. The inner and outer peripheral surfaces define a first radial bearing interface adjacent the closed end of each of the pockets. The retainer has a bearing surface which together with one of the peripheral surfaces define a second radial bearing interface adjacent the open end of each of the pockets. The first and second radial bearing interfaces react and carry an internal moment load to prevent contact of the peripheral surfaces during overrunning.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a view, partially broken away and in cross section, of a prior art overrunning radial brake assembly;

FIG. 2 is a view, partially broken away and in cross section, of a prior art overrunning radial clutch assembly;

FIG. 3 is an exploded perspective view of an overrunning radial coupling assembly constructed in accordance with an embodiment of the present invention with a single pawl and no springs for purposes of simplicity; and

FIG. 4 is a view, partially broken away and in cross section, of the assembly of FIG. 3.

### DETAILED DESCRIPTION OF THE PREFERRED EMBODIMENT(S)

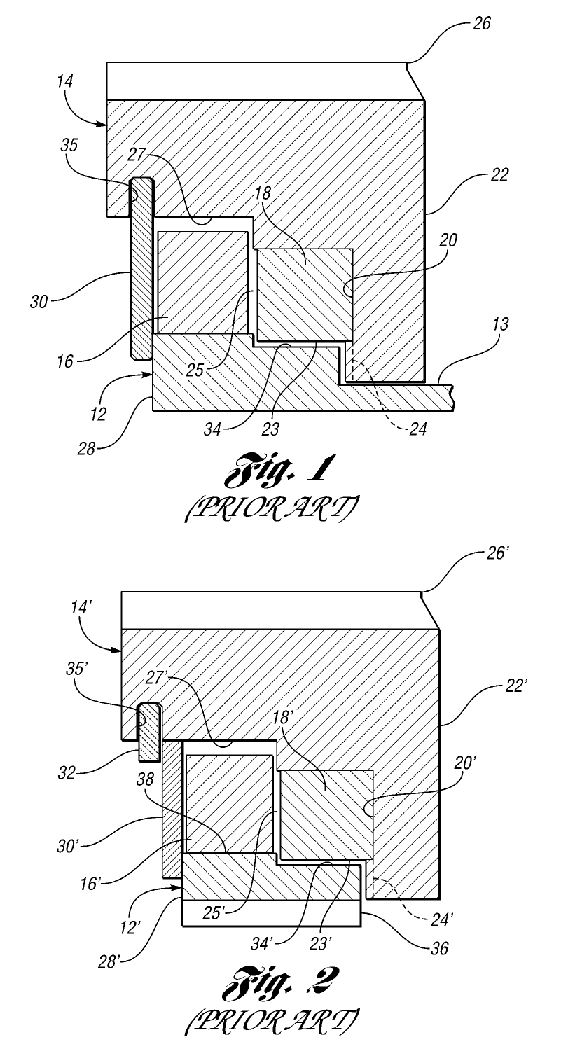

In general, the designs of FIGS. 1 and 2 provide only one radial bearing surface, or piloting surface. For applications that have an internal resultant moment load created because of radial loading, such as ones where the inner plate has splines extended to connect to a driven plate (carrier), a second bearing surface may be necessary during overrun.

There is typically a very close clearance between the outer diameter (i.e., OD) of the rocker or pocket plate and the inner diameter (i.e., ID) of the cam plate and for proper function they cannot touch during overrunning. A second bearing/piloting interface in accordance with one embodiment of the present invention prevents contact under high radial, imbalanced and/or moment loading.

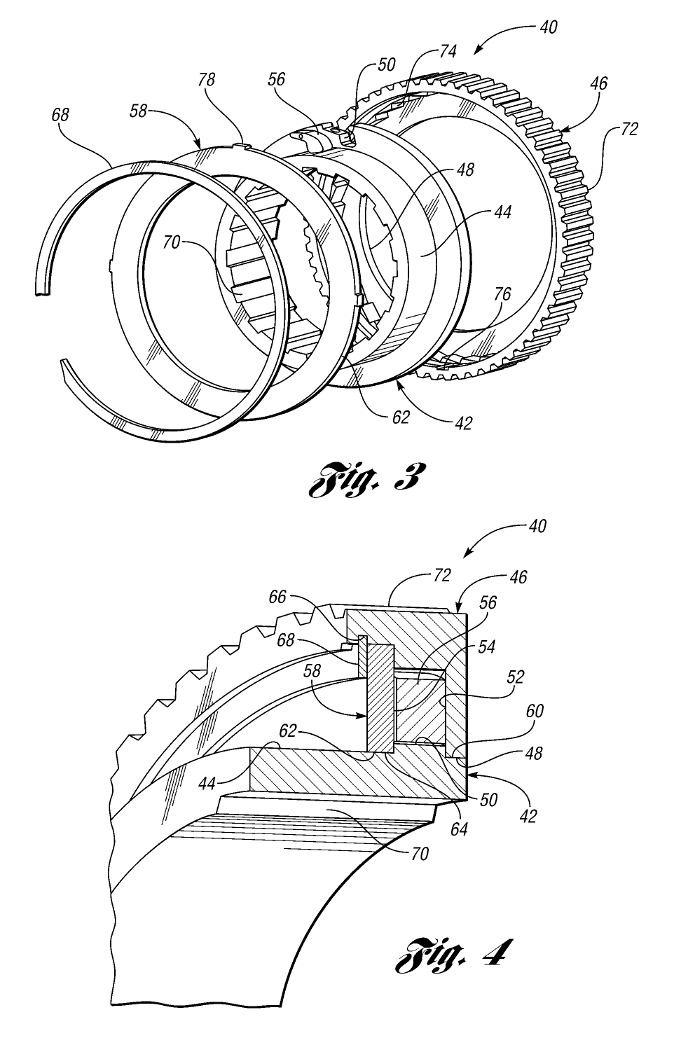

An overrunning radial coupling assembly constructed in accordance with one embodiment of the present invention is generally indicated at 40 in FIGS. 3 and 4. The assembly 40 is preferably a pawl-type one-way clutch assembly having dual bearing support.

The assembly 40 includes an inner plate-like member 42 having an outer peripheral surface 44. The assembly also includes an outer plate-like member 46 having an inner peripheral surface 48 adjacent the outer peripheral surface 44 in radially inner and radially outer relationship. At least one of the members 42 and/or 46 is mounted for rotation about an axis. The member 42 includes pockets 50 angularly spaced about the axis. Each of the pockets 50 has a closed end 52 and an open end 54 located axially opposite the closed end 52.

The assembly 40 further includes a plurality of rockers or pawls 56 (only one of which is shown for simplicity). Each of the pawls 56 is located in its pocket 50 and is supported to pivot toward the peripheral surface 48 of the member 46. The assembly 40 still further includes a retainer, generally indicated at 58, secured to the member 46 and covering the open end 54 of the pockets 50.

The inner and outer peripheral surfaces 48 and 44, respectively, define a first radial bearing interface 60 adjacent the closed end 52 of each of the pockets 50. The retainer 58 has a bearing surface 62 which together with the peripheral surface 44 define a second radial bearing interface 64 adjacent the open end 54 of each of the pockets 50. The first and second radial bearing interfaces 60 and 64, respectively, react and carry an internal moment load to prevent contact of the peripheral surfaces 48 and 44 during overrunning.

The assembly 40 includes biasing members, such as springs (not shown). Each of the biasing members urges a pawl 56 toward the peripheral surface 48 of the member 46.

The retainer 58 preferably is a plate-like bushing. In addition to steel or powdered metal, the material of the retainer 58 may be aluminum, brass/bronze or any other suitable bearing material.

The assembly 40 includes an annular recess 66 located in the member 46 and a snap ring 68 seated in the recess 66 for holding the retainer 58 adjacent the open end 54 of the pockets 50.

Preferably, the inner member 42 is a pocket plate and the outer member 46 is a cam plate. The inner member 42 has splines 70 for driving connection to a driven member or carrier (not shown). The outer member 46 has splines 72 for connection to another member (not shown). Relative rotation between the inner and outer members 42 and 46, respectively, in a direction about an axis of the assembly 40 permits overrunning.

A plurality of notches 74 are formed in the inner peripheral surface 48, and the pawls 56 engage the notches 74 in an engaged position of the assembly 40. The pawls 56 are typically received and retained in the inner member 42 so as to be free-floating.

The retainer 58 preferably includes anti-rotation tabs 78 which are received and retained within corresponding apertures 76 (only one of which is shown) formed in the inner peripheral surface 48 of the outer member 46. The tabs 78 prevent relative rotation between the retainer 58 and the outer member 42.

Unlike the prior art, the assembly 40 has two distinct bearing surfaces or interfaces to react and carry a moment load. The ability to handle a moment load provides the assembly 40 with a number of advantages.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An overrunning radial coupling assembly having dual bearing support, the assembly comprising:
an inner member having an outer peripheral surface;
an outer member having an inner peripheral surface adjacent the outer peripheral surface in radially inner and radially outer relationship, at least one of the members being mounted for rotation about an axis, one of the members including pockets angularly spaced about the axis, each of the pockets having a closed end and an open end located axially opposite the closed end;
a plurality of pawls, each of the pawls being located in a pocket and supported to pivot toward the peripheral surface of the other of the members; and
a retainer secured to one of the members and covering the open end of the pockets, wherein the inner and outer peripheral surfaces define a first radial bearing interface adjacent the closed end of each of the pockets, the retainer having a bearing surface which together with one of the peripheral surfaces define a second radial bearing interface adjacent the open end of each of the pockets and wherein the first and second radial bearing interfaces react and carry an internal moment load to prevent contact of the peripheral surfaces during overrunning.

2. The assembly as claimed in claim 1 further comprising biasing members, each of the biasing members urging a pawl toward the peripheral surface of the other of the members.

3. The assembly as claimed in claim 1 wherein the retainer includes a plate-like bushing.

4. The assembly as claimed in claim 1 further comprising a recess located in one of the members and a snap ring seated in the recess for holding the retainer adjacent the open end of the pockets.

5. The assembly as claimed in claim 1 wherein the inner and outer members comprise plate-like members.

6. The assembly as claimed in claim 1 wherein the coupling assembly is a pawl-type, one-way clutch.

7. The assembly as claimed in claim 5 wherein the inner member is a pocket plate and the outer member is a cam plate.

8. The assembly as claimed in claim 1 wherein the inner member has splines for driving connection to a driven member or carrier.

9. The assembly as claimed in claim 1 wherein the outer member has splines for connection to another member.

10. The assembly as claimed in claim 1 wherein relative rotation between the inner and outer members in a direction about the axis permits overrunning.

11. The assembly as claimed in claim 1 wherein a plurality of notches are formed in one of the peripheral surfaces and wherein the pawls engage the notches in an engaged position of the assembly.

12. The assembly as claimed in claim 1 wherein the pawls are received and retained in the inner member.

13. The assembly as claimed in claim 1 wherein the pawls are received and retained in the pockets so as to be free-floating.

14. An overrunning radial coupling assembly having dual bearing support, the assembly comprising:
an inner member having an outer peripheral surface;
an outer member having an inner peripheral surface adjacent the outer peripheral surface in radially inner and radially outer relationship, at least one of the members being mounted for rotation about an axis, one of the members including pockets angularly spaced about the axis, each of the pockets having a closed end and an open end located axially opposite the closed end;
a plurality of pawls, each of the pawls being located in a pocket and supported to pivot toward the peripheral surface of the other of the members;
biasing members, each of the biasing members urging a pawl toward the peripheral surface of the other of the members; and
a retainer secured to one of the members and covering the open end of the pockets, wherein the inner and outer peripheral surfaces define a first radial bearing interface adjacent the closed end of each of the pockets, the retainer having a bearing surface which together with one of the peripheral surfaces define a second radial bearing interface adjacent the open end of each of the pockets and wherein the first and second radial bearing interfaces react and carry an internal moment load to prevent contact of the peripheral surfaces during overrunning.

15. An overrunning, radial, pawl-type one-way clutch assembly having dual bearing support, the assembly comprising:
an inner member having an outer peripheral surface;
an outer member having an inner peripheral surface adjacent the outer peripheral surface in radially inner and radially outer relationship, at least one of the members being mounted for rotation about an axis, one of the members including pockets angularly spaced about the axis, each of the pockets having a closed end and an open end located axially opposite the closed end;
a plurality of pawls, each of the pawls being located in a pocket and supported to pivot toward the peripheral surface of the other of the members; and
a retainer secured to one of the members and covering the open end of the pockets, wherein the inner and outer peripheral surfaces define a first radial bearing interface adjacent the closed end of each of the pockets, the retainer having a bearing surface which together with one of the peripheral surfaces define a second radial bearing interface adjacent the open end of each of the pockets and wherein the first and second radial bearing interfaces react and carry an internal moment load to prevent contact of the peripheral surfaces during overrunning.
